(19) United States
(12) Patent Application Publication
(10) Pub. No.: US 2005/0108410 A1
(43) Pub. Date: May 19, 2005

(54) Distribution of load to peripheral facilities of a packet-based switching system

(76) Inventor: Norbert Lobig, Darmstadt (DE)

Correspondence Address: Siemens Corporation;Intellectual Property Department, 170 Wood Avenue South, Iselin, NJ, 08830, US

(21) Appl. No.: 10/506,124

(22) PCT Filed: Mar. 7, 2003
(86) PCT No.: PCT/DE03/00740

(30) Foreign Application Priority Data
Mar. 20, 2002 (DE) 10212374.8

(51) Int. Cl. G06F 15/16

(52) U.S. Cl. 709/230

(57) ABSTRACT

The invention relates to a distribution of load to peripheral adaptation units of a packet-based switching system, whereby the peripheral adaptation units serve as an interface between the packet-based switching center and a packet-based communications network. According to the invention, a load that accrues in the switching center is statically or dynamically distributed to the peripheral adaptation units by a load distributor. This enables the periphery adaptation units to be utilized whereby preventing wiring-related overloads and, in addition, being able to take different performance capacities of the peripheral adaptation units into account. When at least one additional switching center is provided upstream, a load budget concerning its use of the peripheral adaptation units can be transmitted thereto from the packet-based switching center. The load distribution is adapted in the event of hardware failures and signaling interferences.

### CROSS REFERENCE TO RELATED APPLICATIONS

This application is the US National Stage of International Application No. PCT/DE03/00740, filed March 7, 2003 and claims the benefit thereof. The International Application claims the benefits of German application No. 10212374.8 filed Mar. 20, 2002, both of the applications are incorporated by reference herein in their entirety.

### FIELD OF INVENTION

The present invention relates to a method for administering a packet-based switch in which peripheral adaptation units are used as the interface between a packet-based communications network and applications of said switch. The applications perform communications and signaling tasks. The invention further relates to an arrangement for administering a packet-based switch in which peripheral adaptation units are used as the interface between a packet-based communications network and applications of said switch, said applications performing communications and signaling tasks.

### BACKGROUND OF INVENTION

The background of the invention is the area of connection between time division multiplex-based communications networks known from conventional telephony, and communications networks in which packet-based network technologies are employed, e.g. implemented in an Internet Protocol (IP)—or ATM-based network. In the course of the convergence of these two types of network, adaptations are required both at the subscriber end and on the switching side. A time division multiplex-based switch provides call control and the termination and through-connection of the user channels. A switch in a packet-based communications network controls the connections and the associated user channels routed outside the switch.

### SUMMARY OF INVENTION

The task of the invention is to provide an improved load distribution to peripheral devices of a packet-based switching system. This is implemented, for example, by means of gateways or resource servers which constitute interfaces for user data streams and control between diverse networks. The user data streams can be controlled, for example, by the Real Time Transport Protocol (RTP), a data transport protocol for the transmission of audio and video data. Control can be provided, for example, by the Media Gateway Control Protocol (MGCP) or by the H.323 protocol, an international standard for voice, data and video communication over packet-based networks.

As well as the conventional analog and ISDN terminals and extensions, terminals suitable for connecting to the packet network and permitting broadband access but additionally supporting the well-known basic features of telephone networks are possible as terminating equipment, using, for example, the H.323 Protocol or also the Session Initiation Protocol (SIP), an application layer signaling control protocol with which multimedia sessions are set up, maintained and terminated. Obvious choices as access medium to the subscriber are both subscriber lines designed for xDSL (Digital Subscriber Line) and the already widespread cable networks. By means of subscriber-end adaptation devices, such as an Integrated Access Device (IAD) or Multimedia Terminal Adapter (MTA) for terminating said access networks, it is possible to connect both broadband customer premises equipment (e.g. PC with Internet access, television receiver, video telephone), and to provide access for conventional subscriber terminal equipment (for example, analog telephone, ISDN telephone, analog or ISDN extension).

Message-based interoffice signaling likewise takes place via the packet-based network (e.g. by means of H.323), provided packet-based switches are involved. If another switch is time division multiplex-based, signaling is performed using the signaling method customary in ISDN/PSTN networks, e.g. by means of country-specific variants of the ISDN User Part Protocol. A signaling gateway for converting the signaling may be necessary. The transition of the user data stream between the time division multiplex- and the packet-based network is through a media gateway controlled by the packet-based switch.

Because of the plurality of specific protocols and the different types of communicating parties, the packet-based switch is equipped with functions known as applications which relate to intercommunication with other time division multiplex- or packet-based switches (virtual trunking), processing of analog and ISDN signaling of conventional subscribers connected on a packet basis (e.g. Voice over DSL (VoDSL), Voice over Cable) or processing of signaling of packet-based subscribers (for example, H.323, SIP). For all call requests, the packet-based switch generally provides means for suitable interworking of the applications. These are selected according to the destinations corresponding to the dialing information, so as to replicate the familiar functions and characteristics of conventional telephony in the packet-based environment for both subscribers and network operators.

So-called peripheral adaptation units are used as physical interfaces between the packet-based switch and the packet-based communications network. These are assigned to specific peripheral devices of the switching system which control the switching sequences of certain subscribers or trunk sets. The peripheral adaptation units generate or receive the signaling—on an application-specific basis—and control the through-connection of the user data stream. In general a plurality of applications (application mix) can be simultaneously active on a peripheral application unit, resulting in application-specific capacity utilizations for a peripheral adaptation unit. At least some of the applications communicate directly with other switches. One such other switch can be present e.g. in the form of an upstream switch or an H.323-compliant gatekeeper.

The assignment between the trunks and/or trunk groups with the applications defined thereon and the peripheral adaptation units is created by a load distributor in the central unit of the packet-based switch. This assignment can be quasi statically preset or is performed dynamically according to the capacity utilization and any failure situations of the hardware of the peripheral adaptation units. In general, therefore, the applications are temporarily connected via peripheral adaptation units to other switches via the hardware of the same peripheral adaptation unit.

It is possible to provide switching for packet-based subscribers if they are using a signaling protocol commonly employed in the packet-based network, such as the H.323 protocol in the IP-based network. This is performed by modeling of the subscriber as part of a concentrator interface of the packet-based switch. Gatekeepers necessary for authorization and having access to the H.323 subscribers of a switch then act as upstream switches, a plurality of peripheral adaptation units generally being assigned to a single gatekeeper in each case. The peripheral adaptation units treat the gatekeepers like H.323 gateways and therefore register cyclically with ‘their’ gatekeeper. If they fail to register, the gatekeeper concludes that the peripheral adaptation unit has failed. The A-side seizures (seizures in the direction of the switch) are distributed to the assigned peripheral adaptation units on a call by call basis without taking account of the loading of the peripheral adaptation units and the performance provided by the hardware.

Conventional subscribers can be connected to a packet network via a peripheral subscriber terminating equipment, their signaling can be forwarded in a packet-based manner to a switch equipped with a suitable adaptation unit where it can be used for call control for the subscriber. More specifically the Stream Control Transmission Protocol is accordingly used to transport the ISDN signaling. The abovementioned technical problem does not occur, as no upstream switch exists for this application, instead all the ports of the applications are used directly via two peripheral adaptation units used in active/standby mode for A- and B-side seizures.

For reasons of reliably accessibility, upstream switches can generally select from a plurality of peripheral adaptation units of said switch (redundant access). This means that at least some of the peripheral adaptation units appear to the upstream switch as a set of signaling gateways for the relevant application. On seizure of the packet-based switch by an upstream switch, selection from a plurality of peripheral adaptation units is consequently possible. However, because of the application mix and their generally different performance characteristics, these have different capabilities in respect of handling a call request. In the case of a seizure performed by the packet-based switch itself, the problem of even capacity utilization of the peripheral adaptation units can be solved, as the capacity utilization of the peripheral adaptation units is known locally. In the case of a seizure in the direction of said switch, however, there is no measure for the time-dependent size of the performance margins of the peripheral adaptation units as a decision criterion for selecting the peripheral adaptation unit to be seized in the upstream switch.

The object of the invention is to improve the loading of peripheral adaptation units in a packet-based switch.

More specifically, the peripheral adaptation units shall be loaded on an application-specific basis in such a way that redundant access to the peripheral adaptation units is possible in both directions (to and from the switch) as part of the options provided by the hardware. During normal operation, if no failure is present, the load resulting from seizures by the packet-based switch and/or by one or more upstream switches shall be distributed to the peripheral adaptation units in such a way that as far as possible none of the peripheral adaptation units is overloaded, thereby supporting an application mix on the peripheral adaptation units with simultaneous use of hardware of differing capability, i.e. different performances of the peripheral adaptation units. A hardware failure shall be tolerated without overloading of a peripheral adaptation unit by the switches involved. Overload handling in the sense of forcing communications traffic back to the periphery of the packet-based switch shall be made possible.

These objects are achieved by the features set forth in the claims.

According to the invention, in a packet-based switch the capacity utilizations of the peripheral adaptation units are determined by a central unit and, on the basis of said capacity utilizations, assignments are created between the trunks and/or trunk groups with the applications defined thereon and the peripheral adaptation units.

More specifically, load indicators are determined which take into account—on an application-specific basis—the resource requirement of the applications and the individual capacity utilizations, the spare resources and the performances of the peripheral adaptation units.

The load indicators can be determined, for example, with the aid of CPU capacity utilization, utilization of operating system resources or size of significant queues.

In terms of planning, the resources must be designed in such a way that the demand resulting from the applications is smaller than the corresponding application-specific resources available.

The assignment must be organized in such a way that the load resulting from seizures, taking the load indicators into account, is distributed as evenly as possible to the peripheral adaptation units.

Determination of the load indicators and any re-assignment of the trunks to the peripheral adaptation units taking said load indicators into account can also take place dynamically, i.e. in small predefined time intervals, for example.

The load indicators are optionally communicated to the upstream switch or switches after assignment, so that in such an upstream switch the resulting load in the direction of said switch can be distributed to the peripheral adaptation units taking the load indicators into account.

The load indicators can be communicated to the upstream switches e.g. as part of the signaling or cyclically repeated registration (see H.323) or by means of an additional communications or control interface.

In the packet-based switch, a load budget can be optionally determined for each of the peripheral adaptation units, said load budget can be appropriately distributed to upstream switches according to capacity utilization criteria and the partial load budget information can be communicated to the upstream switches.

There, this partial load budget information is then in turn used to distribute the load to the peripheral adaptation units of said switch.

Optionally said switch's peripheral adaptation unit last seized by said switch can be used for a new seizure—on an application-specific basis—by the upstream switch.

After a settling time, the subscriber assignment of the peripheral adaptation units set by the load distributing function becomes established for bilateral seizures. In this case the exchange of load budget information between the switches is unnecessary.

### BRIEF DESCRIPTION OF THE DRAWINGS

Further features, advantages and characteristics will now be explained in a detailed description of embodiments with reference to the Figures of the accompanying drawings in which:

FIG. 1 shows the bidirectional access to peripheral adaptation units;

FIG. 2 shows the signaling of the H.323 budgets;

FIG. 3 shows the signaling of the budgets with added margins;

FIG. 4 shows a subscriber-specific approximation of A- and B-side selection of the peripheral adaptation units;

FIG. 5 shows the case of two upstream H.323 gatekeepers;

FIG. 6 shows a failure of an interfaces unit when two upstream H.323 gatekeepers exist and

FIG. 7 shows a failure of a gatekeeper when two upstream H.323 gatekeepers exist.

### DETAILED DESCRIPTION OF INVENTION

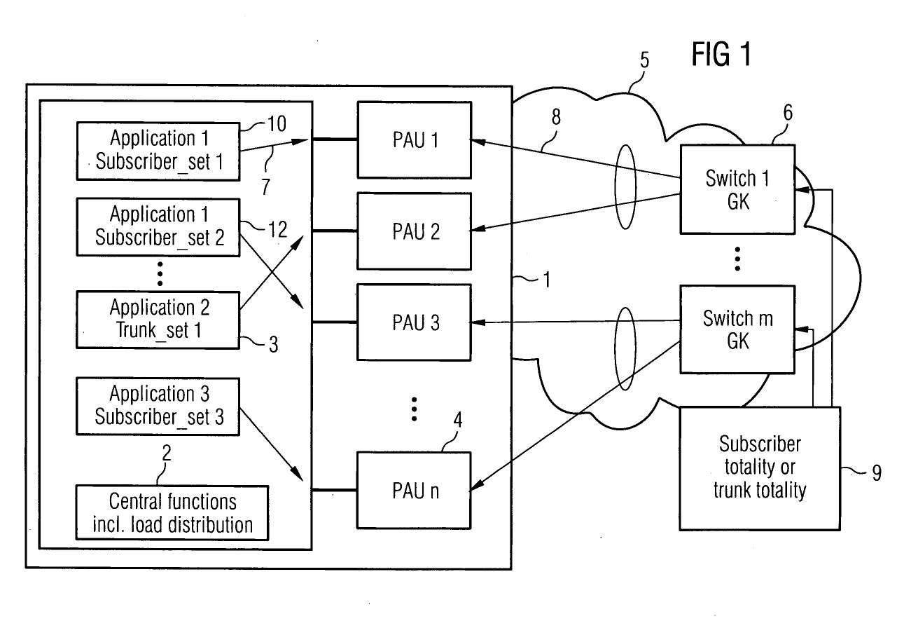

In FIG. 1 the described parts relating to the invention are schematically illustrated. It shows a packet-based switch 1, the load distributing function 2 as part of the coordination processor 11, the switch's peripheral devices for call processing of part of the subscribers and trunks 12 in each case and which are provided e.g. for certain subscriber sets 10 in each case and are designed for certain applications 3 in each case. The applications 3 are active on a plurality of peripheral adaptation units 4. The assignment between the switch's peripheral devices 12 which are designed for certain applications and the peripheral adaptation units 4 are symbolized by arrows 7. The peripheral adaptation units 4 form the interface to the packet-based communications network 5. Additionally visible are two upstream switches 6 which access the peripheral adaptation units 4. This access is symbolized by further arrows 8. The upstream switches are responsible for certain trunk or subscriber totalities 9.

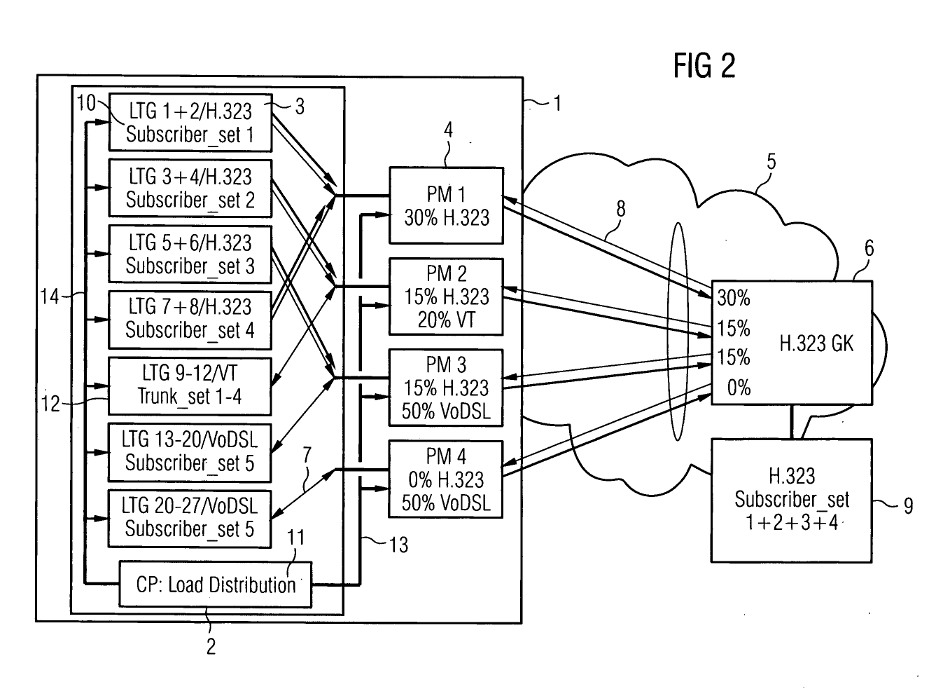

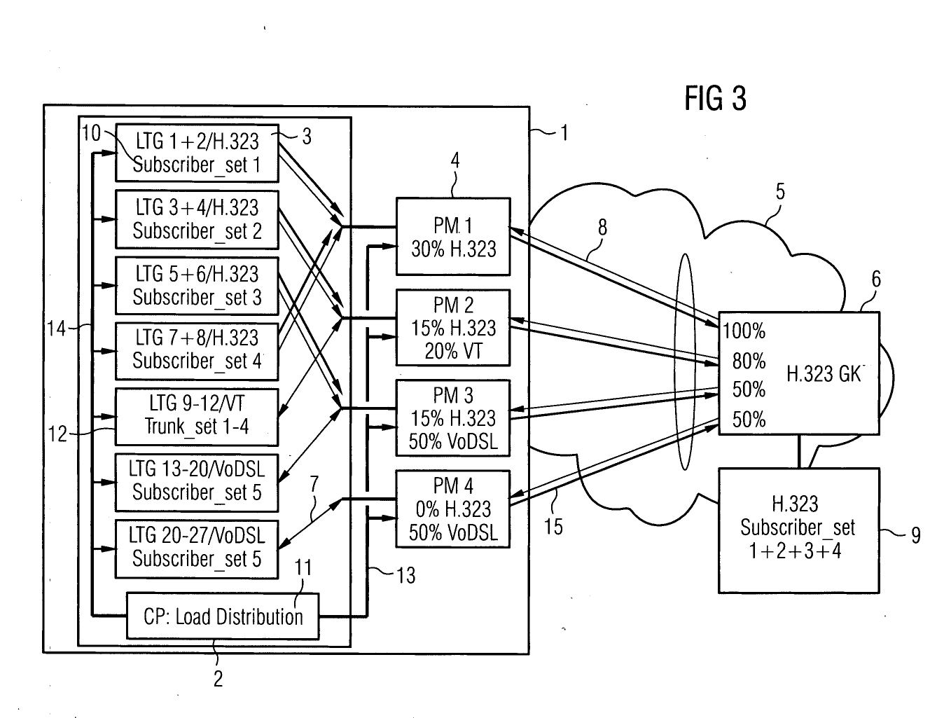

An embodiment of the invention will now be explained in greater detail with reference to FIGS. 2 and 3. FIG. 2 shows the method on the basis of a switch 1 which is designed among other things for an H.323 user access. This example can be implemented analogously for a SIP subscriber access. The packet-based switch 1 contains peripheral devices with application-specific switching tasks for a certain subset of the periphery of the switching system. In the example illustrated, the applications supported are the three applications 3 H.323, Virtual Trunking (VT) and VoDSL. A total of five subscriber totalities 10 are available to the peripheral devices designed for these applications.

There is additionally a totality of trunks of the Virtual Trunking application.

The applications 3 are active on four so-called packet managers 4 functioning here as peripheral adaptation units. In the example shown, the assignment of the peripheral devices 12 designed for these applications to the packet Managers 4 for the VoDSL application is performed statically, VoDSL being assigned to the packet managers numbers three and four. For the H.323 and VT applications, the assignment is performed dynamically by the central load distributor 2 which is part of the coordination processor 11.

The coordination processor 11 communicates to the peripheral devices 12 designed for the relevant application the packet managers 4 assigned to them. This is represented by further arrows 14. In the example all four packet managers 4 are designed for the H.323 application, the packet manager number two additionally for the VT application and the packet managers numbers three and four for the H.323 und VoDSL applications.

The load distributor 2 determines load indicators for each packet manager 4 on an application-specific basis and send them to the packet managers 4. This is represented by a further arrow 13. These load indicators are specified in FIG. 2 on an application-specific basis as a percentage of the capacity of a packet manager 4. The assignment between the applications on the peripheral devices of the switching system 12 and the packet managers 4 is symbolically represented by arrows 7.

The assignment between the H.323 and VT applications and the packet managers 4 is performed dynamically, and therefore generally changes at certain time intervals.

FIG. 2 therefore shows a momentary assignment state characterized in that, for B-side seizures of one of the peripheral devices 12 numbers one to eight providing the H.323 application, one of the packet managers numbers one to three is used, as the packet manager number four has been assigned 0% by the load distributor 2 as load indicator for the H.323 application.

The packet managers 4 therefore constitute the physical interface to the packet-based communications network 5 and via the latter to a gatekeeper 6 functioning as an upstream switch. The gatekeeper serves the H.323 subscriber totalities 9 which are assigned to the peripheral devices numbers one to eight. The packet managers 4 are used by the gatekeeper 6 as gateways and normally register cyclically with the gatekeeper 6. As part of this registration they communicate to the gatekeeper 6 the load indicators temporarily assigned to them, shown here specifically for the H.323 application. This is indicated by arrows 15 from the packet managers 4 to the gatekeeper 6. This ensures that in the event of a change in the assignment between the peripheral devices 12 for the H.323 application and the packet managers 4, the load indicators are communicated to the gatekeeper 6 in an uncomplicated manner. For B-side calls (performed by the switch 1), a peripheral device and application assigned to the relevant subscribers is used and therefore the packet manager 4 assigned by the load distributor 2 is used for the signaling to the gatekeeper 6. This means that it is not necessary to decide separately for each call which of the packet managers 4 is to be used.

FIG. 3 shows the optional case in which the load budgets communicated to the upstream gatekeepers 6 are selected larger than resulting from the original load distribution. This constitutes an option for the case of there being budget margins on the packet managers 4 which can be provided e.g. by underwiring or because of unused redundancy.

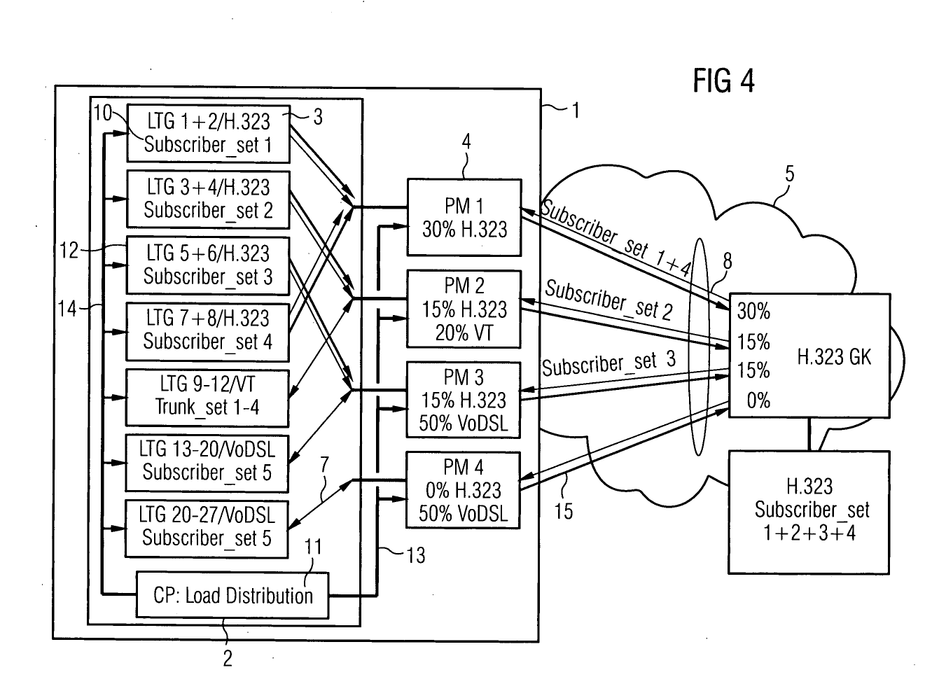

The following FIGS. 4 to 7 contain the same components as FIG. 2. Unless otherwise described below, the same conditions apply to FIGS. 4 to 7 as in FIG. 2.

According to FIG. 4, the forward signaling of the load indicators by the packet managers 4 to the gatekeeper 6 can be dispensed with if the packet manager 4 via which a B-side seizure for an H.323 subscriber last occurred is registered with the gatekeeper 6 and if that packet manager is used for A-side seizure of that subscriber. After a certain settling time, for A- and B-side seizures by H.323 subscribers, this method produces a capacity utilization of the packet managers 4 corresponding to the load indicators specified by the load distributor 2 for the packet managers 4. In the example, the subscriber sets 10 numbers one and four have been momentarily assigned the packet manager 4 number one by the load distributor/coordination processor 2. Correspondingly, the subscriber set 10 number two is assigned the packet manager 4 number two and the subscriber set 10 number three is assigned the packet manager 4 number three. The four subscriber sets 9 are served by the gatekeeper 6 and have already adjusted to the same assignment. This procedure simplifies the engineering of the packet-based switch 1, as the conditions of conventional concentrator interfaces are replicated in which the signaling of subscribers always takes place via the same peripheral components of the switching system.

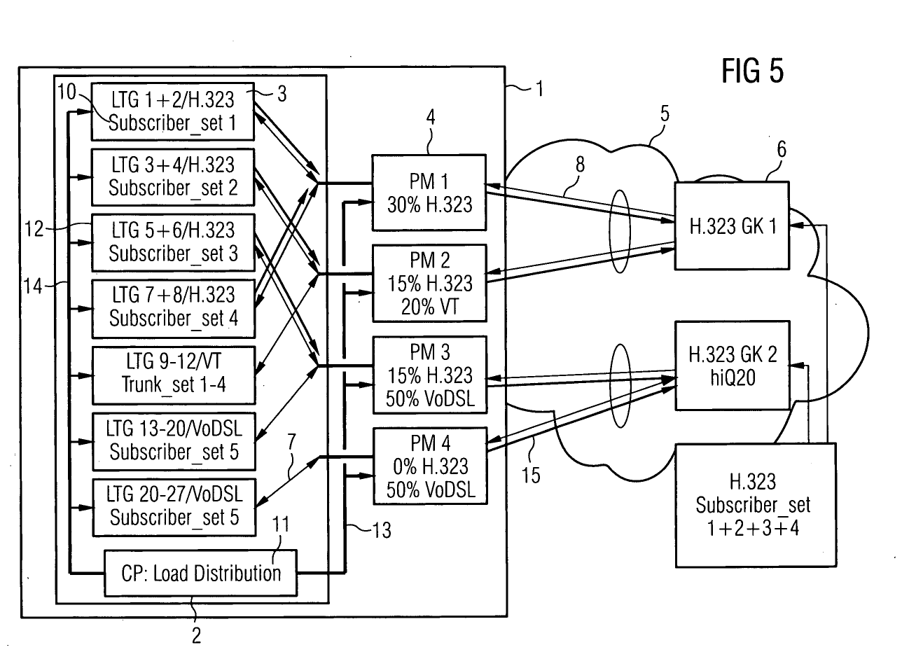

FIG. 5 shows an example for the scenario with two gatekeepers 6. The gatekeeper 6 number one has access to the packet managers 4 numbers one and three, whereas the gatekeeper 6 number two has access to the packet managers 4 numbers three and four. In this case a load budget is determined in switch 1 for each packet manager 4 on the basis of the load indicators. This load budget is then signaled to the gatekeepers 6 in a manner analogous to that described above as part of the cyclical registration of the packet managers 4 and is then in turn used for deciding which of the packet managers 4 is to be used for A-side seizures.

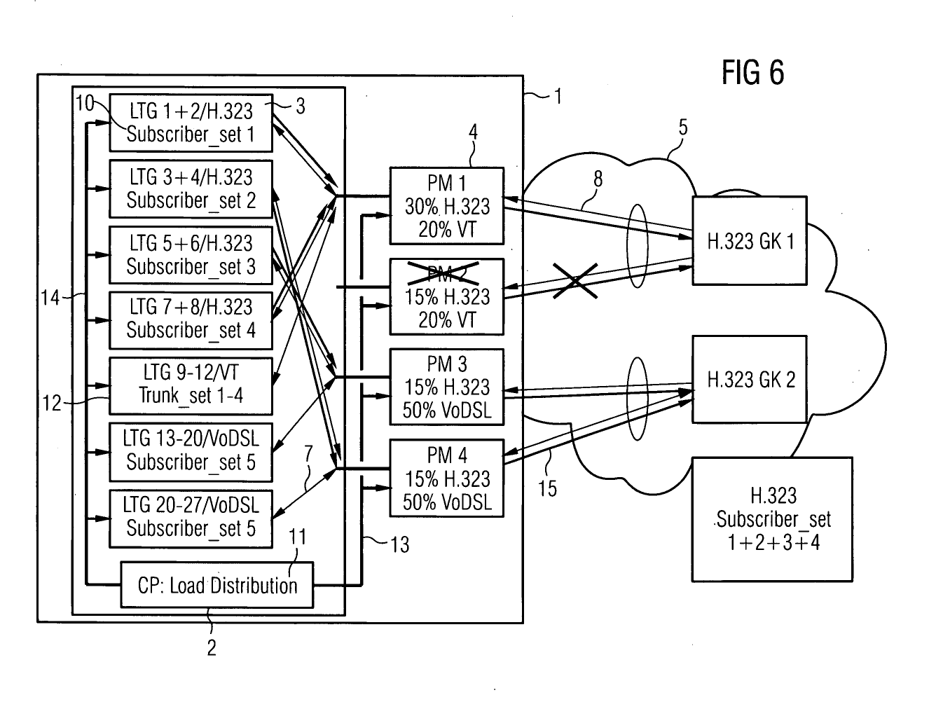

FIG. 6 schematically illustrates how, following hardware failure of the packet manager 4 number two, the assignments between the peripheral devices and their applications 12 and the packet managers 4 can be restored by the load distributor 2. In the example shown, the H.323 subscriber seizures processed prior to the failure by the packet manager 4 number two (load indicator 15%) are taken over by the packet manager 4 number four after the failure. Similarly, the VT seizures processed prior to the failure by the packet manager 4 number two (load indicator 20%) are taken over by the packet manager 4 number one after the failure.

Because packet manager 4 number two has not registered, the gatekeeper 6 number has decided that it has failed and will therefore not use it again for the time being. Only the packet manager 4 number one is now available to the gatekeeper 6 number one as a communication connection to switch 1 for H.323 seizures.

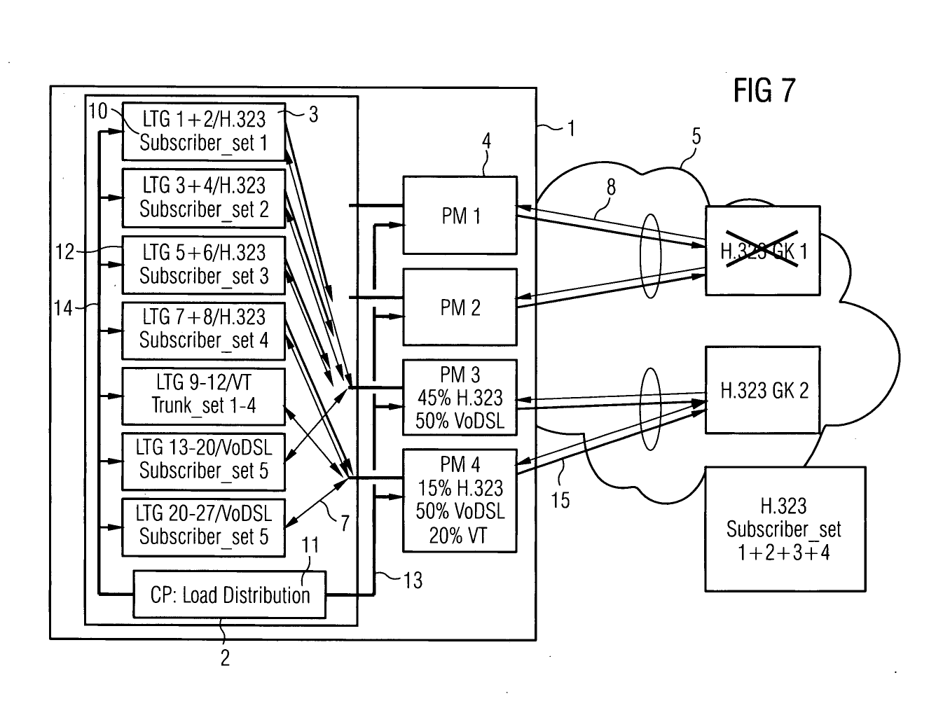

FIG. 7 illustrates hardware failure of the gatekeeper 6 number one. This failure is revealed to switch 1 by the loss of communication/signaling. The load distributor then uses only the packet managers 4 numbers three and four for the new assignments of all trunks for H.323 subscribers, as these packet managers are connected to the operational gatekeeper 6 number two.

The advantages of the invention may be summarized as follows:
Comprehensive load distribution to the interfaces units (peripheral adaptation units) by means of a single load distribution algorithm and therefore avoidance of uncoordinated load from the periphery of the packet-based switch
Optionally additional support of dynamically determined load indicators for load distribution
Can also be used in multi-homing scenarios in which, as seen from an upstream or remote packet-based switch, selection from a plurality of packet-based switches equipped with peripheral adaptation units is possible
Simplified engineering of the switch due to the fact that, with predictable loading during undisturbed normal operation and in standby mode, e.g. in the event of hardware failures, the assignment of subscribers and trunks is reduced to the assignment of hardware units to the applications and intercommunication of the peripheral adaptation units
Dynamically favorable load distribution from the viewpoint of the packet-based switch, as distribution to a plurality of peripheral adaptation units does not have to be decided on a per call or per signaling message basis
Easy allowance for peripheral adaptation units of differing performance.

1-17. (canceled)

18. A method for load distribution in a packet-based switch in which peripheral adaptation units are used as the interface between a packet-based communications network and applications of the switch, the method comprising:
performing communication and/or signaling tasks by the applications;
determining the individual workloads of the peripheral adaptation units; and
forming an assignment between the applications and the peripheral adaptation units depending on the determined workloads.

19. A method according to claim 18, further comprising:
determining load indicators for the peripheral adaptation units in the switch on an application-specific basis depending on the resource requirement of the applications, and/or the individual workload, and/or the spare resources, and/or the performance of the peripheral adaptation unit; and
using the load indicators for the assignment between the applications and the peripheral adaptation units.

20. A method according to claim 19, wherein the load indicators are determined by using the CPU workload and/or the workload of operating system resources and/or the size of significant queues.

21. A method according to claim 18, wherein the resources of the peripheral adaptation units exceed or do not cover the resource requirement of the applications assigned to them.

22. A method according to claim 19, wherein at least some of the load indicators are determined dynamically and any re-assignment of the applications to the peripheral adaptation units is performed dynamically taking said load indicators into account.

23. A method according to claim 19, wherein the load indicators are communicated to at least one of the upstream switches and that at least one upstream switch distributes the load produced in the direction of the switch to the peripheral adaptation units taking into account the load indicators communicated to it.

24. A method according to claim 23, wherein the information is communicated to the upstream switches as part of the signaling or of the cyclically repeated registration or by an additional communication or control interface.

25. A method according to claim 19, further comprising:
generating a load budget for at least one of the peripheral adaptation units as a function of the load indicators;
distributing the load budget among the upstream switches in the form of partial load budget information; and
distributing the load produced in the direction of the switch to the peripheral adaptation units by the upstream switches using the partial load budget information.

26. A method according to claim 18, wherein, in the case of a new seizure of a subscriber or trunk, switches upstream of the packet-based switch seize, on an application-specific basis, the peripheral adaptation unit last used by the switch to seize said subscriber or said trunk.

27. A method according to claim 18, wherein, in the event of failure of at least one of the peripheral adaptation units, and/or applications, and/or upstream switches, a re-assignment between the applications and the peripheral adaptation units takes place.

28. An arrangement for load distribution in a packet-based switch in which peripheral adaptation units are used as interface between a packet-based communications network and applications of the switch, wherein the applications performing communication and/or signaling tasks, the arrangement comprising:
a mechanism for determining the individual workloads of the peripheral adaptation units and for distributing the load to the peripheral adaptation units taking the individual workloads determined into account.

29. An arrangement according to claim 28, further comprising:
a mechanism for determining individual, application-specific load indicators for the peripheral adaptation units as a function of the resource requirement of the applications, and/or the workload, and/or spare resources, and/or performance of the peripheral adaptation unit; and
a mechanism for assignment between the applications and the peripheral adaptation units using the load indicators.

30. An arrangement according to claim 28, further comprising:
a mechanism for dynamically recording the load indicators and for dynamically re-assigning the applications to the peripheral adaptation units using the load indicators.

31. An arrangement according to claim 28, further comprising:
a mechanism for communicating the load indicators from the switch to at least one of the upstream switches; and
a mechanism for distributing the load produced in the upstream switch in the direction of the to the peripheral adaptation units of the switch taking the load indicators into account.

32. An arrangement according to claim 28, further comprising:
a mechanism for generating individual load budgets for at least one of the peripheral adaptation units as a function of the load indicators, for distributing said load budget to the upstream switches in the form of partial load budget information and for distributing the load produced in the upstream switch in the direction of the switch to the peripheral adaptation units of the switch using the partial load budget information.

33. An arrangement according to claim 28, further comprising:
a mechanism for application-specific seizure of the peripheral adaptation unit last used by the switch for the subscriber or trunk to be seized, the mechanism being used by the upstream switch.

34. An arrangement according to claim 28, further comprising:
a mechanism for re-assignment between the applications and the peripheral adaptation units in the event of failure of at least one of the peripheral adaptation units, and/or applications, and/or upstream switches.
